(19) United States
(12) Patent Application Publication
(10) Pub. No.: US 2023/0103896 A1
(43) Pub. Date: Apr. 6, 2023

(54) CONFIGURING DYNAMIC INTERACTIONS BETWEEN APPLICATION ELEMENTS

(71) Applicant: salesforce.com, inc., San Francisco, CA (US)

(72) Inventors: Viswanadh Addala, Los Gatos, CA (US); Jan Ove Kristian Olsson, Castro Valley, CA (US); Prakhar Jain, Hyderabad (IN); Aayushi Bhargava, Emeryville, CA (US); Adheip Varadarajan, Orinda, CA (US); Dean Taylor Moses, Berkeley, CA (US); Farhan Tahir, Toronto (CA); Pavan Kumar Yadav, Hyderabad (IN)

(21) Appl. No.: 17/489,284

(22) Filed: Sep. 29, 2021

(51) Int. Cl. G06F 9/451; G06F 3/0482; G06F 3/0483; G06F 9/445

(52) U.S. Cl. CPC G06F 9/451; G06F 3/0482; G06F 3/0483; G06F 9/44505; G06F 9/44521

(57) ABSTRACT

An application server may load a set of elements configured for use in an application. In some examples, a subset of the set of elements may include metadata enabling dynamic interactions between the subset of the set of elements. The application server may receive a selection of a source element and an event associated with the source element. In some examples, the event may include transmission of a data packet from the source element in response to a trigger at the source element, and the event and a payload of the data packet may be configured in accordance with the metadata associated with the source element. The application server may receive a selection of a target element and an input field. The application server may then store a dynamic interaction between the source element and the target element for the application.

### FIELD OF TECHNOLOGY

The present disclosure relates generally to database systems and data processing, and more specifically to configuring dynamic interactions between application elements.

### BACKGROUND

A cloud platform (i.e., a computing platform for cloud computing) may be employed by many users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

A database system may store data objects, such as objects corresponding to contacts or business data, and the objects may be requested by external client systems (e.g., chat applications, client devices, etc.). Database systems may also support application builder programs. Current systems may define a static connection between multiple application elements in the application builder programs. Current systems do not support dynamic and customizable connections between application elements.

### BRIEF DESCRIPTION OF THE DRAWINGS

FIG. 1 illustrates an example of a data processing at an application server system that supports configuring dynamic interactions between application elements in accordance with aspects of the present disclosure.

FIG. 2 illustrates an example of an environment that supports configuring dynamic interactions between application elements in accordance with aspects of the present disclosure.

FIG. 3 illustrates an example of a block diagram that supports configuring dynamic interactions between application elements in accordance with aspects of the present disclosure.

FIG. 4 illustrates an example of a user interface that supports configuring dynamic interactions between application elements in accordance with aspects of the present disclosure.

FIG. 5 illustrates an example of a process flow that supports configuring dynamic interactions between application elements in accordance with aspects of the present disclosure.

FIG. 6 shows a block diagram of an apparatus that supports configuring dynamic interactions between application elements in accordance with aspects of the present disclosure.

FIG. 7 shows a block diagram of a data processing module that supports configuring dynamic interactions between application elements in accordance with aspects of the present disclosure.

FIG. 8 shows a diagram of a system including a device that supports configuring dynamic interactions between application elements in accordance with aspects of the present disclosure.

FIGS. 9 through 12 show flowcharts illustrating methods that support configuring dynamic interactions between application elements in accordance with aspects of the present disclosure.

### DETAILED DESCRIPTION

A tenant of a multi-tenant database may store information and data for users, customers, organizations, etc. in a database. For example, the tenant may manage and store data and metadata for exchanges, opportunities, deals, assets, customer information, and the like. The tenant may query the database in ways to extract meaningful information from the data, which may assist the tenant in future decision making and analysis. In some cases, a report may include the data query and an appropriate title which describes the queried data in terms and conventions often used by the tenant. These reports, queries, and interactions, as well as corresponding metadata, may also be stored in the databases. A user may be able to combine or cross-analyze multiple reports to further extract meaningful data and information.

A database system may support application builder programs. For application builder programs, a user (e.g., an administrator) may not be able to connect or configure dynamic interactions between multiple components or services using a low-code or no-code process. Dynamic interactions between multiple components may be configured when two components or services are linked up such that interacting with one component (e.g., clicking a record in a list view) causes another component (e.g., a map component) to update in some way (e.g., show the address of the record that was clicked). With the lack of dynamic interactions between elements, developers may build custom, hardcoded, programmatic solutions to achieve the capability of dynamic interactions. In particular, a developer of a system may have to be involved in building a hard-coded back-end connection between multiple components.

One or more aspects of the present disclosure enable administrators to declaratively configure interactions between different, independent components and services without the need for hard-coded connections. For example, aspects depicted herein describe techniques for users to integrate interactions between elements (e.g., components and services) using visual tools. In some examples, a user may configure a component to indicate when an event is triggered (e.g., buttonPress event is trigged at an application builder program). An administrator (or other non-developer) may then visually connect the triggered event to a target event. The administrator may configure a source component or service to interact with another component or service in the system (e.g., update another component or invoke a service like navigateToPage). The aspects of the present disclosure provides for an administrator interacting with the user interface using back-end technical architecture and metadata. The user interface supporting dynamic interactions may be powered by the dynamic interactions architecture, where the administrators (or other non-developers) may configure connections between components or services based on one or more events (e.g., within an application builder program). In particular, the events may be created by component developers in the back-end. The component developers may also declare events associated with a set of components. In some examples, the component may be a Lightning Web Component including a javascript that triggers Document Object Model (DOM) events. The component developers may also designate additional declarative metadata to include while exposing this event to builders (e.g., other non-developers). At runtime, when a user selects a source component or service on an application server, the application server may retrieve corresponding metadata from a database. Based on the metadata, the components and corresponding interactions (html, javascript) may be generated dynamically and sent to the user (e.g., client). Thus, a client may use a page powered by the dynamic interactions.

According to some examples, a system may identify or load a set of components configured for building an application in a visual application tool (such as Lightning App Builder). The set of components may be configured for use in an application. In some aspects, a subset of the set of components may include metadata enabling dynamic interactions between the subset of the set of components. In some aspects, the dynamic interactions may include dynamically inputting data at one or more target elements based on data packets that are transmitted from one or more source elements (e.g., source components and/or source service).

A user interacting with the application may select a source component and an event associated with the source component. The event may define transmission of the data packet associated with the source component. For instance, the event may include transmission of a data packet from the source component in response to a trigger at the source component. In some examples, the event and a payload of the data packet are configured in accordance with the metadata associated with the source component. The user may further select a target component and an input field for the target component, where the input field may correspond to the event associated with the source component. Upon receiving the configuration for the source component and the target component, the system may store a dynamic interaction between the source component and the target component for the application. At runtime, a user may select the source component and the event corresponding to the source component. Utilizing the stored dynamic interactions, the system may transmit an interaction associated with the target component based on receiving the selection of the source component and the event during the runtime of the application.

Aspects of the disclosure are initially described in the context of an environment supporting an on-demand database service. Aspects of the disclosure are further illustrated by and described with reference to an environment, a block diagram, a user interface, and a process flow. Aspects of the disclosure are further illustrated by and described with reference to apparatus diagrams, system diagrams, and flowcharts that relate to configuring dynamic interactions between application elements.

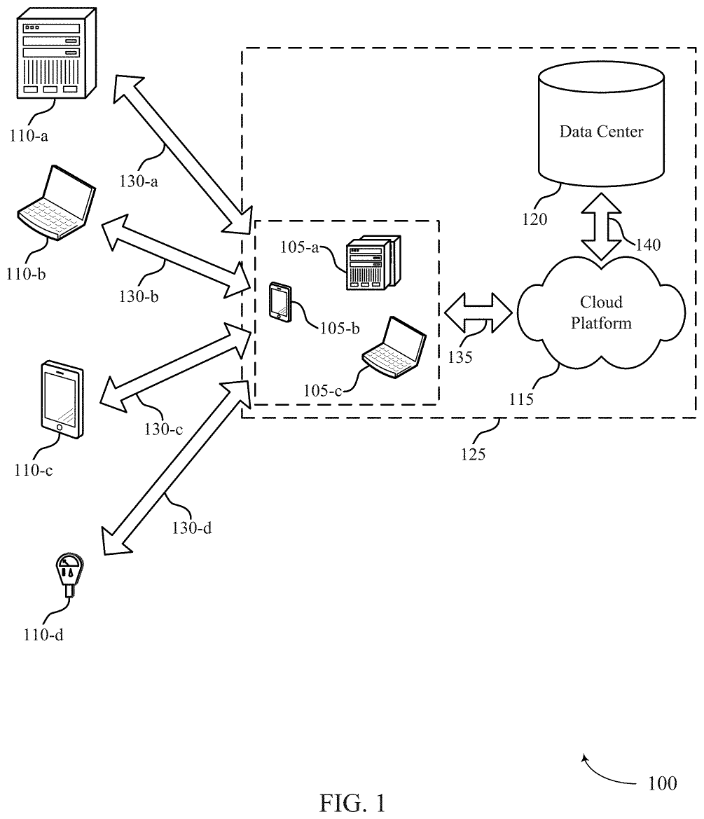

FIG. 1 illustrates an example of a system 100 for cloud computing that supports configuring dynamic interactions between application elements in accordance with various aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to some applications, data, and database information within cloud platform 115 based on the associated security or permission level, and may not have access to others. Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135, and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

The cloud platform 115 may further support a dynamic interaction service. Dynamic interactions may provide an ability for non-developers to establish interactions between elements (e.g., components and services) using visual tools. For example, a component can declare that an event has been triggered (e.g., buttonPress). Upon identifying the trigger of an event, a user (e.g., administrator) may visually connect the trigger to target or interact with another element in the system (e.g., update another component or invoke a service like navigateToPage).

The dynamic interaction service may provide dynamic interactions for different components and services stored at the data center 120. Further, the dynamic interaction service may support a user interface in which administrators may design dynamic interactions for different components and services. For example, an administrator for a cloud client 105 may design dynamic interactions between for different components and services, which may correspond to users for particular contacts 110. Accordingly, when users associated with the cloud client 105 triggers an event corresponding to a source component or service, then the cloud platform 115 may render a target component or service at the client system based on rendering retrieving metadata associated with the source component or service and metadata associated with the target component or service (from data center 120).

In conventional systems, dynamic interaction capabilities may be achieved based on developers building custom, hardcoded, programmatic solutions. As a specific example, a user may submit a request for dynamic interactions to the developers. The developer may hardcode the solution for a particular pair to source and target elements and a corresponding event. Such a solution is not scalable and is limited to static interaction between elements. In addition, it may take a long time to hardcode each interaction between elements. Conventional systems thus lack the capability of dynamically configuring interactions between elements in a system.

In contrast, in accordance with aspects of the present disclosure, the cloud platform 115 provides a dynamic interaction service which provides customizable dynamic interactions which are served to client systems. Aspects of the present disclosure provide for very little or no configuration of the client systems themselves. Rather, the dynamic interaction service provides an application building tool (or application configuration program), which may be used by clients (using client systems) to store dynamic interactions between a source element (component or service) and a target element (component or service). The client system may transmit a selection of a source element and an event associated with the source element. The event may include transmission of a data packet from the source element in response to a trigger at the source element. In some examples, the event and a payload of the data packet are configured in accordance with metadata associated with the source element. The client system may further transmit a selection of a target element and an input field for the target element. The input field may correspond to the event associated with the source element. The cloud platform 115 may store the dynamic interaction between the source element and the target element. Accordingly, at runtime, the cloud platform 115 may render dynamic interactions associated with a target element upon receiving an input selecting the source element. As such, client systems may utilize the dynamic interactions without storing corresponding user interface configurations.

It should be appreciated by a person skilled in the art that one or more aspects of the disclosure may be implemented in a system 100 to additionally or alternatively solve other problems than those described herein. Further, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

As an example, employees or persons associated with an organization (e.g., a cloud client 105) may utilize Lightning App builder to build components and services for internal usage. An administrator for the organization may utilize the dynamic interaction service of the cloud platform 115 to configure manners in which source and target elements are linked. In particular, the administrator may configure the manner in which source and target elements are to be displayed to users of the workspace. The administrator may specify that when a user selects an account name from a first component (a list of account names), then a second component (list of account details) may display the account details corresponding to the account name selected in the first component. The configured dynamic interaction may correspond to an event “item selected” so that the account details are dynamically updated when an item (e.g., account) is selected in the list of account names.

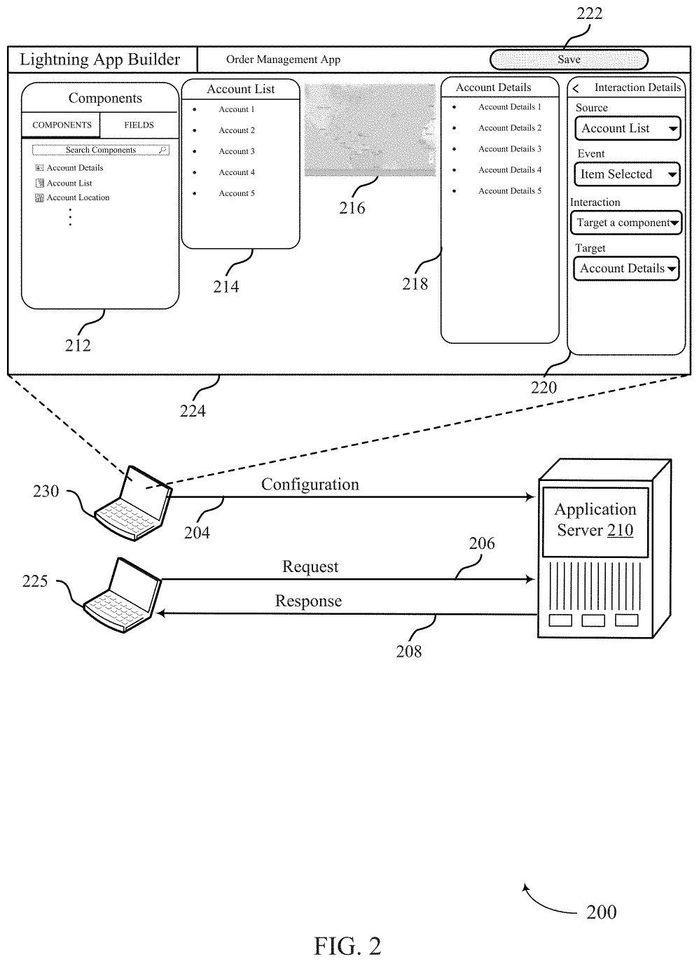

FIG. 2 illustrates an example of an environment 200 that supports configuring dynamic interactions between application elements in accordance with aspects of the present disclosure. The environment 200 may implement aspects of the system 100 of FIG. 1. For example, the environment 200 includes an application server 210, which may be an example of aspects of cloud platform 115 of FIG. 1, and user devices 230 and 225, which may be examples of devices associated with a cloud client 105 of FIG. 1.

At user device 230 a user or administrator (e.g., of a cloud client 105) may access a user interface 224 supported by the application server 210. The user or administrator may configure a dynamic interactions between application elements. The user interface 224 may include a set of elements (e.g., components or service) configured for use in an application. As depicted in the example of FIG. 2, the set of elements may be included in the pane 212. A subset of the set of elements or components may include metadata enabling dynamic interactions between the subset of the set of elements or components. Additionally or alternatively, the dynamic interactions may include dynamically inputting data at one or more target elements or components based on data packets that are transmitted from one or more source elements or components. A user or administrator (e.g., of a cloud client 105) may use the user interface 224 and back-end technical architecture and metadata to generate dynamic interactions between elements. The user interface 224 may be powered by the dynamic interactions architecture, which are used by administrators to wire components together with events. These events in the back-end are created by component developers who declare events associated with one or more components. A component, as depicted herein, may be a Lightning Web Component, which has javascript that triggers DOM events. The component developers may also declare additional declarative metadata to expose this event to users. In some examples, the component developers may generate the event using the following code (where the event is pressing a button and the schema represents a payload of the event):

| | |
|---|---|
| 1. | <targetConfig targets=“lightning_{——}AppPage”> |
| 2. | [..] |
| 3. | <event name=“onButtonPress”> |
| 4. | <schema> |
| 5. | { |
| 6. | “type”: “object”, |
| 7. | “properties”: { |
| 8. | “data”: { |
| 9. | “type”: “string” |
| 10. | } |
| 11. | } |
| 12. | } |
| 13. | </schema> |
| 14. | </event> |
| 15. | </targetConfig> |

Additionally or alternatively, component developers may create headless services that can invoke an external system or application programming interface. A service may be a headless Lightning Web Component (e.g., it includes javascript) using methods to implement logic. The component developers may then declare additional metadata for users to know what methods are exposed for declarative use. In some examples, the component developers may generate the event using the following code (where the event is navigating to a page and the schema represents a payload of the event):

| | |
|---|---|
| 1. | <targetConfig targets=“lightning_{——}AppPage_Service”> |
| 2. | [..] |
| 3. | <method name=“navigateToPage”> |
| 4. | <schema> |
| 5. | { |
| 6. | “type”: “object”, |
| 7. | “properties”: { |
| 8. | “pageName”: { |
| 9. | “type”: “string” |
| 10. | } |
| 11. | } |
| 12. | } |
| 13. | </schema> |
| 14. | </event> |
| 15. | </targetConfig> |

As depicted in the example of FIG. 2, the user may drag and drop different components and fields from pane 212 to the user interface 224. For example, the user may initiate an account list component 214, an account location component 216 and an account details components 218. The user may then select a source component and an event associated with the source component. The panel 220 listing interaction details shows that the user selects the source component as the account list component. Additionally, the user may select an event correspond to the source component. In the example of FIG. 2, the user may select the event as item selected. The developers may configure the user interface 224 such that selection of the event includes transmission of a data packet from the source component in response to a trigger at the source component. In some examples, the event and a payload of the data packet are configured in accordance with the metadata associated with the source component.

In FIG. 2, the user may then select a target component and an event associated with the source component. The panel 220 listing interaction details shows that the user selects the target component as the account details component. The user may input a selection of the target component and an input field for the target component. The input field may correspond to the event associated with the source component. The user may further select an interaction associated with the source component and a corresponding interaction associated with the target component. Although not depicted in the example of FIG. 2, the user may select the corresponding interaction associated with the target component from a drop down list of predefined interactions. The developers may configure the drop down list of predefined interactions. The user may save the dynamic interaction using the save button 222 on the user interface 224.

Upon receiving the configuration 204, the application server 210 may store the dynamic interaction between the source component and the target component. For example, the user may configure that upon selection of an account (e.g., Account 1) from the account list component 214, the user interface 224 may display the account details corresponding to the Account 1 (e.g., Account Details 1) in the account details components 218. In some cases, the user or administrator may configure different dynamic interactions for different components as well as for different services. Based on the configuration by the administrator at the user interface 224, a set of interaction details may be stored in a dynamic interaction library supported by the application server 210. The dynamic interaction library may be associated with an organization, a particular client system used by the organization, etc.

In FIG. 2, a user may utilize an application (e.g., Lightning App Builder) with a user interface at user device 225. The user may select a source component (via request 206) and may input a trigger (e.g., an event designated as trigger by the administrator) associated with source component. For example, the user may select “Account 2” from the source component “Account List.” That is, the application server 210 may determine that the event “item selected” is triggered by the user. Upon detecting the trigger, the application server 210 may retrieve metadata associated with the source component and a corresponding target component (e.g., the component designated as the target by the administrator). The application server 210 may determine that a data packet is transmitted in response to the “item selected” trigger. A payload of the data packet may be configured in accordance with the metadata associated with the source component. The application server 210 may then transmit a response 208 indicating an interaction associated with the target component. For example, the application server 210 may display the account details in the target component “Account Details” corresponding to the selected “Account 2” from the source component “Account List.”

It should be understood that the implementations described herein are applicable to many different components and services, including and without limitation, component to component communication, (e.g., list of items, clicking item shows details of item within the same page), communication with external service or application programming interface (e.g., click a button to send a text message, invoke an action, start a flow, etc.), navigating to a page or within a page (e.g., a button to navigate to another page, a wizard with previous or next buttons on each tab within a page, navigation between tabs, etc.), or a combination thereof. Thus, the aspects depicted herein provides an ability for non-technical users to declaratively configure interactions between a source element and a target element.

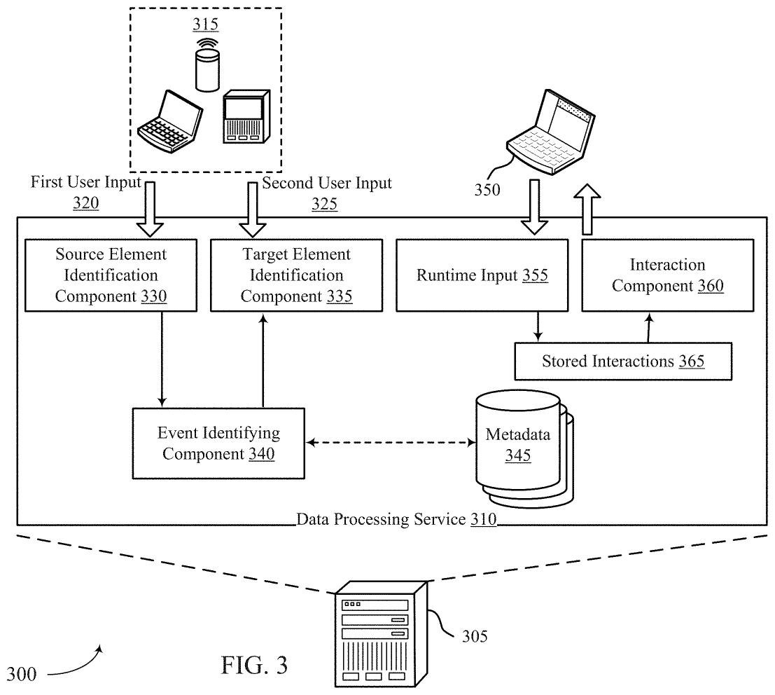

FIG. 3 illustrates an example of a block diagram 300 that supports configuring dynamic interactions between application elements in accordance with aspects of the present disclosure. The devices of block diagram 300 may implement aspects of the system 100 of FIG. 1 and/ or environment 200 of FIG. 2. The block diagram 300 includes a server 305, which may be an example of aspects of the server 210 of FIG. 2, and the server 305 executes an data processing service 310. The block diagram 300 further includes a user device 315 (depicted as a cluster of devices), and a user device 350. Although depicted as separate user devices, it may be understood that user device 315 and user device 350 may be the same device. Example user devices 315 may include computing devices, smart devices, virtual assistants, etc., and the user device 315 may include servers supporting such systems (e.g., search servers, application servers, etc.). The user device 315 may transmit a set of instructions to the server 305. The set of instructions may be transmitted to configure a dynamic interaction using a user interface supported by the server 305.

An instruction interface of the server 305 may include a source element identification component 330 and a target element identification component 335. The server 305 may receive a first user input 320. The first user input 320 may indicate a selection of a source element and an event associated with the source element. The event identifying component 340 may identify the event associated with the source element. The event may include transmission of a data packet from the source element in response to a trigger at the source element. The identifying component 340 may identify a payload of the data packet in accordance with the metadata 345. In some cases, the server 305 is a multi-tenant database system, and as such, manages different libraries storing metadata 345 for different clients (e.g., cloud clients 105 of FIG. 1).

The data processing service 310 further receives a second user input 325 from the user device 315, which may be examples of devices associated with cloud client 105 of FIG. 1. The second user input 325 may be transmitted responsive to the first user input 320. The second user input 325 may include a selection of a target element and an input field for the target element, where the input field corresponds to the event associated with the source element. The second user input 325 may be received at an interface, which may parse the input to identify the indicated target element, and the input field. The server 305 may store a dynamic interaction between the source element and the target element for an application supported by the server 305.

At runtime, a runtime input component 355 of the data processing service 310 may receive an input from the user device 350. The input may include selection of the source element (the source element stored with dynamic interactions). The data processing service 310 identifies the source element and identifies a set of stored interactions 365 corresponding to the runtime input and the trigger associated with the source element. For example, if the user device 350 performs a triggering action on the source element, then the runtime input 355 component may retrieve a dynamic interaction associated with the source element from the set of stored interactions 365. The interaction component 360 may then transmit an interaction associated with the target element based on receiving the selection of the source element and the event during the runtime of the application and the stored dynamic interaction between the source element and the target element. The output may include displaying data corresponding to the target element, upon receiving a selection corresponding to the source element. As depicted herein, the source element is independent from the target component during loading the set of elements in the user interface of an application configuration program supported by the server 305.

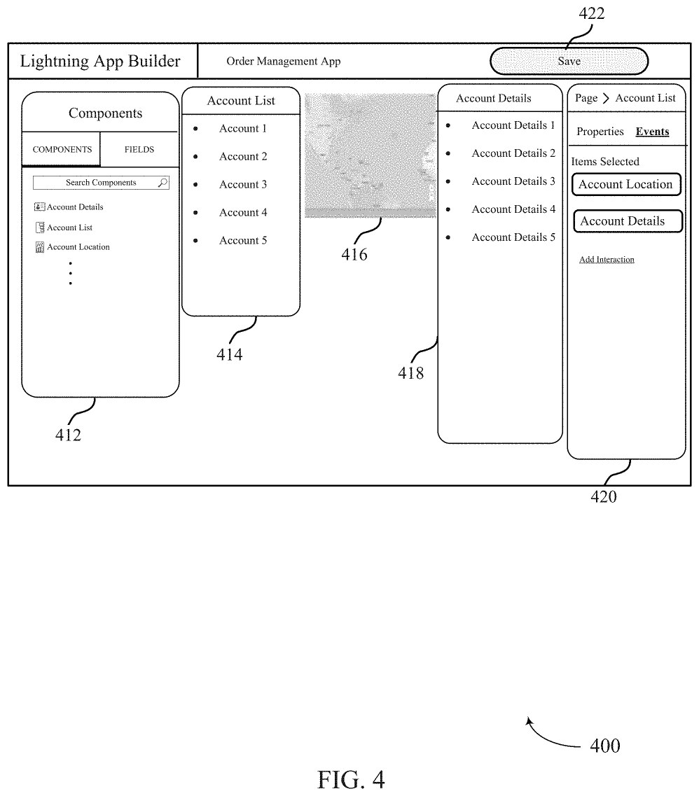

FIG. 4 illustrates an example of a user interface 400 that supports configuring dynamic interactions between application elements in accordance with aspects of the present disclosure. The user interface 400 may correspond to a desktop or mobile or other user interface type. In some cases, additional user interface types may be supported for implementing dynamic interactions between application elements (e.g., components and services). The user interface 400 may support a first view of dynamic interactions.

As depicted herein, a user of a device may be associated with a tenant of a multi-tenant database which has been using the cloud platform for data management. The user interface 400 may be a part of a cloud platform that supports multiple data records. The user interface 400 may display a view of an application configuration program supported by an application server. As depicted in the example of FIG. 4, the user interface 400 may support a set of components configured for use in an application. As depicted in the example of FIG. 4, the set of components may be included in the pane 412. A subset of the set of components may include metadata enabling dynamic interactions between the subset of the set of components. In the example depicted herein, a user device may configure dynamic interactions between the components “Account List,” “Account Location,” and “Account Details.”

A user may drag and drop different components and fields from pane 412 to the user interface 400. For example, the user may initiate an account list component 414, an account location component 416 and an account details components 418. The user may then select a source component and an event associated with the source component according to aspects depicted herein. For example, the user may utilize the user interface described with reference to FIG. 2 to select the source component. In the example of FIG. 4, the user may select the account list component 414 as the source component. The aspects of the present disclosure may support configuring and storing multiple dynamic interactions.

The user interface 400 may include a panel 420 displaying the details associated with the stored dynamic interactions. As depicted herein, the panel 420 may include dynamic interactions between the account list component 414 (source component) and the account details component (target component). Additionally, the panel 420 may include dynamic interactions between the account list component 414 (source component) and the account location component (target component). For example, upon selection of an account (e.g., Account 1) from the account list component 414, the user interface 400 may display the account details corresponding to the Account 1 (e.g., Account Details 1) in the account details components 418. Similarly, upon selection of an account (e.g., Account 1) from the account list component 414, the user interface 400 may display the account location corresponding to the Account 1 in the account location component 416. Thus, by implement dynamic interactions, the user interface 400 may improve application performance and user experience.

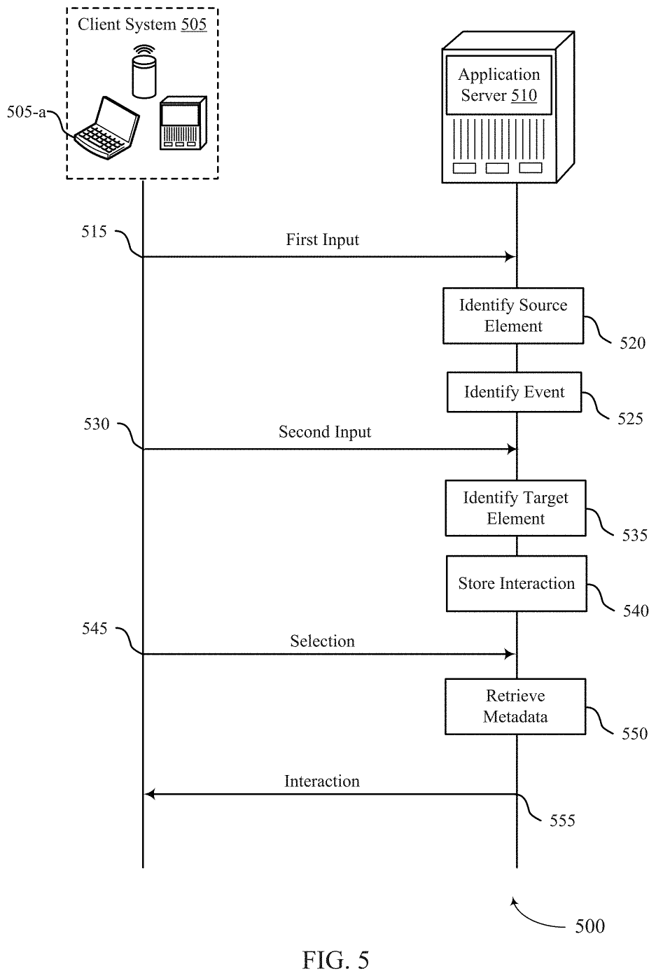

FIG. 5 illustrates an example of a process flow 500 that supports configuring dynamic interactions between application elements in accordance with aspects of the present disclosure. The process flow 500 may implement aspects of system 100 of FIG. 1 and includes a user device 505 (e.g., a set of user devices), which may be examples of devices associated with cloud client 105 of FIG. 1. Example user devices 505 include computing devices, smart devices, virtual assistants, etc. and the user device 505 may include servers supporting such systems (e.g., search servers, application servers, etc.). The process flow 500 further includes an application server 510, which may be an example of aspects of cloud platform 115 of FIG. 1 and may be an example of aspects of the application server 210 of FIG. 2 (e.g., a database system, application server, etc.) and the server 305 of FIG. 3.

The application server 210 may load, in a user interface of an application configuration program, a set of elements configured for use in an application. In some examples, a subset of the set of elements may include metadata enabling dynamic interactions between the subset of the set of elements. The dynamic interactions may include dynamically inputting data at one or more target elements based on data packets that are transmitted from one or more source elements. At 515, the user device 505 may transmits a selection of a source element and an event associated with the source element. In some examples, the user device 505 may transmit a selection of an interaction associated with the source element

At 520, the application server 510 may identify the source element and at 525, the application server 510 may identify the event associated with the source element. In some examples, the event includes transmission of a data packet from the source element in response to a trigger at the source element. In some examples, the event and a payload of the data packet are configured in accordance with the metadata associated with the source element.

At 530, the user device 505 may transmit a selection of a target element and an input field for the target element. In some examples, the input field corresponds to the event associated with the source element. The user device 505 may transmit a selection of a corresponding interaction associated with the source element. In some examples, the user device 505 may transmit the selection of the corresponding interaction from a drop down list of predefined interactions.

At 535, the application server 510 may identify the target element based on receiving the selection from the user device 505. In some examples, the application server 510 may identify a selection of an interaction with an external application programming interface for executing a second event corresponding to the event associated with the source element. In some examples, the application server 510 may identify the selection of a service configured to navigate to a second webpage in response to receiving the selection of the event associated with the source element. Additionally or alternatively, the application server 510 may identify the selection of a service configured to navigate from a first tab to a second tab in the webpage in response to receiving the selection of the event associated with the source element. At 540, the application server 510 may store a dynamic interaction between the source element and the target element for the application.

At 545, the user device 505 may transmit, during runtime of the application, a selection of the source element and the event. At 550, the application server 510 may retrieve, from a database and in response to receiving selection of the source element and the event during the runtime of the application, the metadata associated with the source element and metadata associated with the target element.

At 550, the application server 510 may transmit an interaction associated with the target element based on receiving the selection of the source element and the event during the runtime of the application and the stored dynamic interaction between the source element and the target element. In some examples, transmitting the interaction may be based on retrieving the metadata associated with the source element and the metadata associated with the target element.

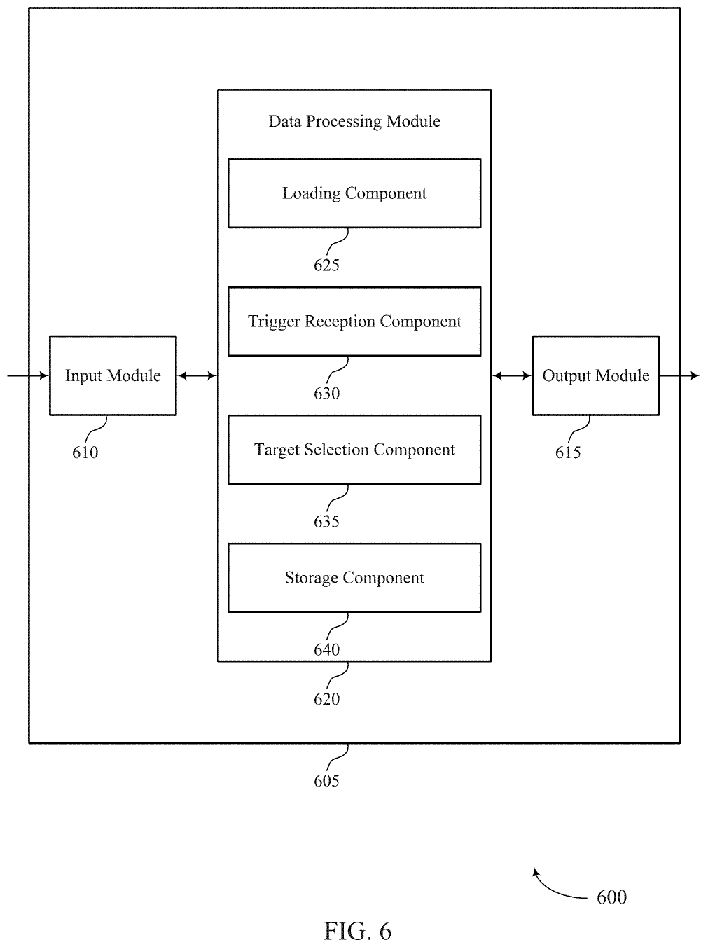

FIG. 6 shows a block diagram 600 of a device 605 that supports configuring dynamic interactions between application elements in accordance with aspects of the present disclosure. The device 605 may include an input module 610, an output module 615, and a data processing module 620. The device 605 may also include a processor. Each of these components may be in communication with one another (e.g., via one or more buses).

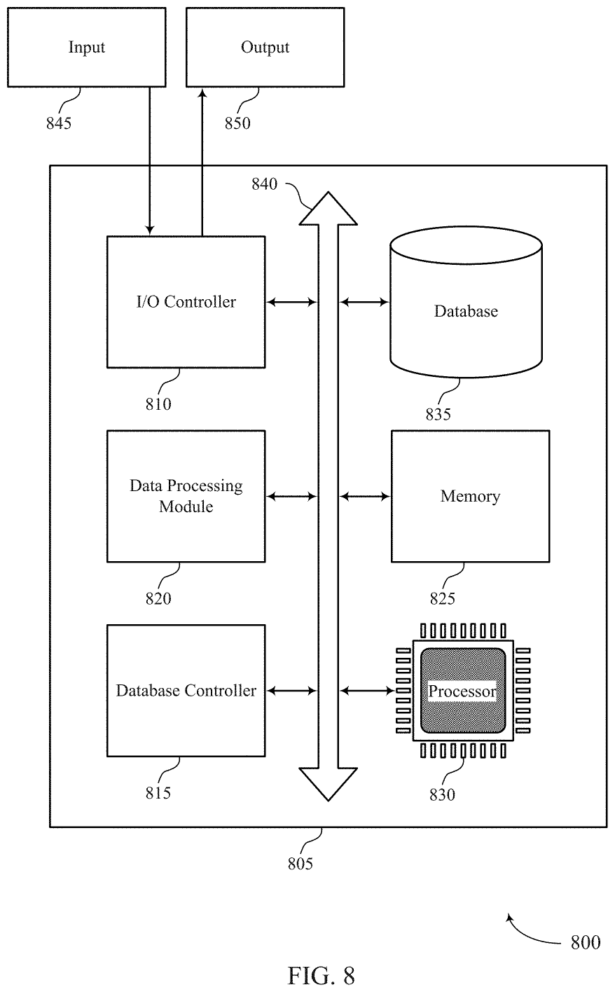

The input module 610 may manage input signals for the device 605. For example, the input module 610 may identify input signals based on an interaction with a modem, a keyboard, a mouse, a touchscreen, or a similar device. These input signals may be associated with user input or processing at other components or devices. In some cases, the input module 610 may utilize an operating system such as iOS®, ANDROID®, MS-DOS®, MS-WINDOWS®, OS/2®, UNIX®, LINUX®, or another known operating system to handle input signals. The input module 610 may send aspects of these input signals to other components of the device 605 for processing. For example, the input module 610 may transmit input signals to the {PRIMARY_MODULE} 620 to support configuring dynamic interactions between application elements. In some cases, the input module 610 may be a component of an I/O controller 810 as described with reference to FIG. 8.

The output module 615 may manage output signals for the device 605. For example, the output module 615 may receive signals from other components of the device 605, such as the {PRIMARY_MODULE} 620, and may transmit these signals to other components or devices. In some examples, the output module 615 may transmit output signals for display in a user interface, for storage in a database or data store, for further processing at a server or server cluster, or for any other processes at any number of devices or systems. In some cases, the output module 615 may be a component of an I/O controller 810 as described with reference to FIG. 8.

For example, the data processing module 620 may include a loading component 625, a trigger reception component 630, a target selection component 635, a storage component 640, or any combination thereof. In some examples, the data processing module 620, or various components thereof, may be configured to perform various operations (e.g., receiving, monitoring, transmitting) using or otherwise in cooperation with the input module 610, the output module 615, or both. For example, the data processing module 620 may receive information from the input module 610, send information to the output module 615, or be integrated in combination with the input module 610, the output module 615, or both to receive information, transmit information, or perform various other operations as described herein.

The data processing module 620 may support data processing at an application server in accordance with examples as disclosed herein. The loading component 625 may be configured as or otherwise support a means for loading, in a user interface of an application configuration program, a set of elements configured for use in an application, wherein a subset of the set of elements comprises metadata enabling dynamic interactions between the subset of the set of elements, and wherein the dynamic interactions comprise dynamically inputting data at one or more target elements based at least in part on data packets that are transmitted from one or more source elements. The trigger reception component 630 may be configured as or otherwise support a means for receiving, via a first user input in the user interface, a selection of a source element and an event associated with the source element, wherein the event comprises transmission of a data packet from the source element in response to a trigger at the source element, and wherein the event and a payload of the data packet are configured in accordance with the metadata associated with the source element. The target selection component 635 may be configured as or otherwise support a means for receiving, via a second user input in the user interface, a selection of a target element and an input field for the target element, wherein the input field corresponds to the event associated with the source element. The storage component 640 may be configured as or otherwise support a means for storing a dynamic interaction between the source element and the target element for the application.

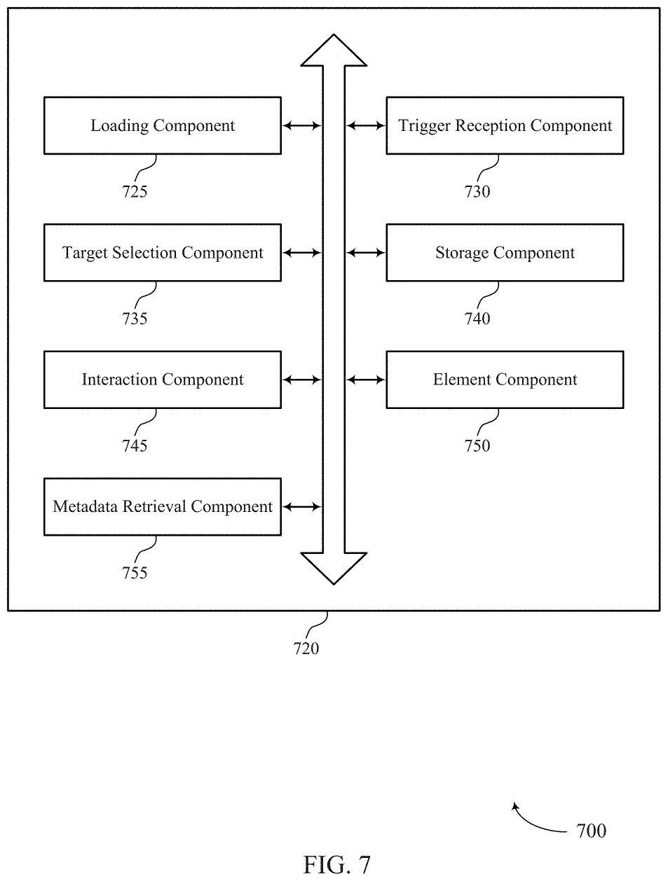

FIG. 7 shows a block diagram 700 of a data processing module 720 that supports configuring dynamic interactions between application elements in accordance with aspects of the present disclosure. The data processing module 720 may be an example of aspects of a data processing module or a data processing module 620, or both, as described herein. The data processing module 720, or various components thereof, may be an example of means for performing various aspects of configuring dynamic interactions between application elements as described herein. For example, the data processing module 720 may include a loading component 725, a trigger reception component 730, a target selection component 735, a storage component 740, an interaction component 745, an element component 750, a metadata retrieval component 755, or any combination thereof. Each of these components may communicate, directly or indirectly, with one another (e.g., via one or more buses).

The data processing module 720 may support data processing at an application server in accordance with examples as disclosed herein. The loading component 725 may be configured as or otherwise support a means for loading, in a user interface of an application configuration program, a set of elements configured for use in an application, wherein a subset of the set of elements comprises metadata enabling dynamic interactions between the subset of the set of elements, and wherein the dynamic interactions comprise dynamically inputting data at one or more target elements based at least in part on data packets that are transmitted from one or more source elements. The trigger reception component 730 may be configured as or otherwise support a means for receiving, via a first user input in the user interface, a selection of a source element and an event associated with the source element, wherein the event comprises transmission of a data packet from the source element in response to a trigger at the source element, and wherein the event and a payload of the data packet are configured in accordance with the metadata associated with the source element. The target selection component 735 may be configured as or otherwise support a means for receiving, via a second user input in the user interface, a selection of a target element and an input field for the target element, wherein the input field corresponds to the event associated with the source element. The storage component 740 may be configured as or otherwise support a means for storing a dynamic interaction between the source element and the target element for the application.

In some examples, the interaction component 745 may be configured as or otherwise support a means for receiving, via the first user input in the user interface, a selection of an interaction associated with the source element. In some examples, the interaction component 745 may be configured as or otherwise support a means for receiving, via the second user input in the user interface, a selection of a corresponding interaction associated with the target element.

In some examples, to support receiving the selection of the corresponding interaction, the interaction component 745 may be configured as or otherwise support a means for receiving, via the second user input in the user interface, the selection of the corresponding interaction from a drop down list of predefined interactions.

In some examples, to support receiving the selection of the target element and the input field, the interaction component 745 may be configured as or otherwise support a means for receiving, via the second user input in the user interface, the selection of an interaction with an external application programming interface for executing a second event corresponding to the event associated with the source element.

In some examples, to support receiving the selection of the target element and the input field, the interaction component 745 may be configured as or otherwise support a means for receiving, via the second user input in the user interface comprising a first webpage, the selection of a service configured to navigate to a second webpage in response to receiving the selection of the event associated with the source element.

In some examples, to support receiving the selection of the target element and the input field, the interaction component 745 may be configured as or otherwise support a means for receiving, via the second user input in the user interface comprising a webpage, the selection of a service configured to navigate from a first tab to a second tab in the webpage in response to receiving the selection of the event associated with the source element.

In some examples, the element component 750 may be configured as or otherwise support a means for receiving, during runtime of the application, a selection of the source element and the event. In some examples, the interaction component 745 may be configured as or otherwise support a means for transmitting an interaction associated with the target element based at least in part on receiving the selection of the source element and the event during the runtime of the application and the stored dynamic interaction between the source element and the target element.

In some examples, the metadata retrieval component 755 may be configured as or otherwise support a means for retrieving, from a database and in response to receiving selection of the source element and the event during the runtime of the application, the metadata associated with the source element and metadata associated with the target element, wherein transmitting the interaction is based at least in part on retrieving the metadata associated with the source element and the metadata associated with the target element.

In some examples, the element comprises at least one of a component configured for use in the application, a service, an application programming interface, or a combination thereof.

In some examples, the source element is independent from the target component during loading the set of elements in the user interface of the application configuration program.

FIG. 8 shows a diagram of a system 800 including a device 805 that supports configuring dynamic interactions between application elements in accordance with aspects of the present disclosure. The device 805 may be an example of or include the components of a device 605 as described herein. The device 805 may include components for bi-directional data communications including components for transmitting and receiving communications, such as a data processing module 820, an I/O controller 810, a database controller 815, a memory 825, a processor 830, and a database 835. These components may be in electronic communication or otherwise coupled (e.g., operatively, communicatively, functionally, electronically, electrically) via one or more buses (e.g., a bus 840).

The I/O controller 810 may manage input signals 845 and output signals 850 for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. In other cases, the I/O controller 810 may represent or interact with a modem, a keyboard, a mouse, a touchscreen, or a similar device. In some cases, the I/O controller 810 may be implemented as part of a processor 830. In some examples, a user may interact with the device 805 via the I/O controller 810 or via hardware components controlled by the I/O controller 810.

The database controller 815 may manage data storage and processing in a database 835. In some cases, a user may interact with the database controller 815. In other cases, the database controller 815 may operate automatically without user interaction. The database 835 may be an example of a single database, a distributed database, multiple distributed databases, a data store, a data lake, or an emergency backup database.

Memory 825 may include random-access memory (RAM) and ROM. The memory 825 may store computer-readable, computer-executable software including instructions that, when executed, cause the processor 830 to perform various functions described herein. In some cases, the memory 825 may contain, among other things, a BIOS which may control basic hardware or software operation such as the interaction with peripheral components or devices.

The processor 830 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 830 may be configured to operate a memory array using a memory controller. In other cases, a memory controller may be integrated into the processor 830. The processor 830 may be configured to execute computer-readable instructions stored in a memory 825 to perform various functions (e.g., functions or tasks supporting configuring dynamic interactions between application elements).

The data processing module 820 may support data processing at an application server in accordance with examples as disclosed herein. For example, the data processing module 820 may be configured as or otherwise support a means for loading, in a user interface of an application configuration program, a set of elements configuring for use in an application, wherein a subset of the set of elements comprises metadata enabling dynamic interactions between the subset of the set of elements, and wherein the dynamic interactions comprise dynamically inputting data at one or more target elements based at least in part on data packets that are transmitted from one or more source elements. The data processing module 820 may be configured as or otherwise support a means for receiving, via a first user input in the user interface, a selection of a source element and an event associated with the source element, wherein the event comprises transmission of a data packet from the source element in response to a trigger at the source element, and wherein the event and a payload of the data packet are configured in accordance with the metadata associated with the source element. The data processing module 820 may be configured as or otherwise support a means for receiving, via a second user input in the user interface, a selection of a target element and an input field for the target element, wherein the input field corresponds to the event associated with the source element. The data processing module 820 may be configured as or otherwise support a means for storing a dynamic interaction between the source element and the target element for the application.

By including or configuring the data processing module 820 in accordance with examples as described herein, the device 805 may support techniques for enhanced flexibility, improved coordination between devices, and improved utilization of processing capability.

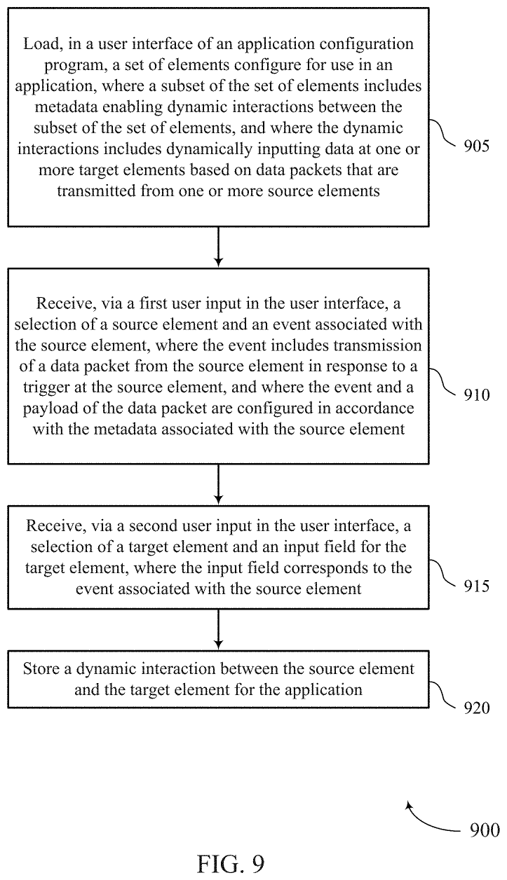

FIG. 9 shows a flowchart illustrating a method 900 that supports configuring dynamic interactions between application elements in accordance with aspects of the present disclosure. The operations of the method 900 may be implemented by an application server or its components as described herein. For example, the operations of the method 900 may be performed by an application server as described with reference to FIGS. 1 through 8. In some examples, an application server may execute a set of instructions to control the functional elements of the application server to perform the described functions. Additionally or alternatively, the application server may perform aspects of the described functions using special-purpose hardware.

At 905, the method may include loading, in a user interface of an application configuration program, a set of elements configured for use in an application, wherein a subset of the set of elements comprises metadata enabling dynamic interactions between the subset of the set of elements, and wherein the dynamic interactions comprise dynamically inputting data at one or more target elements based at least in part on data packets that are transmitted from one or more source elements. The operations of 905 may be performed in accordance with examples as disclosed herein. In some examples, aspects of the operations of 905 may be performed by a loading component 725 as described with reference to FIG. 7.

At 910, the method may include receiving, via a first user input in the user interface, a selection of a source element and an event associated with the source element, wherein the event comprises transmission of a data packet from the source element in response to a trigger at the source element, and wherein the event and a payload of the data packet are configured in accordance with the metadata associated with the source element. The operations of 910 may be performed in accordance with examples as disclosed herein. In some examples, aspects of the operations of 910 may be performed by a trigger reception component 730 as described with reference to FIG. 7.

At 915, the method may include receiving, via a second user input in the user interface, a selection of a target element and an input field for the target element, wherein the input field corresponds to the event associated with the source element. The operations of 915 may be performed in accordance with examples as disclosed herein. In some examples, aspects of the operations of 915 may be performed by a target selection component 735 as described with reference to FIG. 7.

At 920, the method may include storing a dynamic interaction between the source element and the target element for the application. The operations of 920 may be performed in accordance with examples as disclosed herein. In some examples, aspects of the operations of 920 may be performed by a storage component 740 as described with reference to FIG. 7.

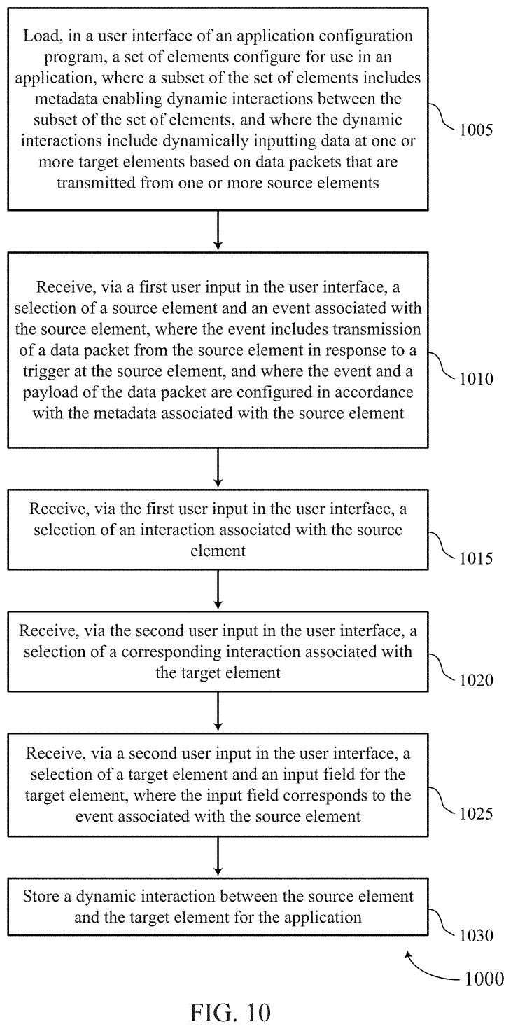

FIG. 10 shows a flowchart illustrating a method 1000 that supports configuring dynamic interactions between application elements in accordance with aspects of the present disclosure. The operations of the method 1000 may be implemented by an application server or its components as described herein. For example, the operations of the method 1000 may be performed by an application server as described with reference to FIGS. 1 through 8. In some examples, an application server may execute a set of instructions to control the functional elements of the application server to perform the described functions. Additionally or alternatively, the application server may perform aspects of the described functions using special-purpose hardware.

At 1005, the method may include loading, in a user interface of an application configuration program, a set of elements configured for use in an application, wherein a subset of the set of elements comprises metadata enabling dynamic interactions between the subset of the set of elements, and wherein the dynamic interactions comprise dynamically inputting data at one or more target elements based at least in part on data packets that are transmitted from one or more source elements. The operations of 1005 may be performed in accordance with examples as disclosed herein. In some examples, aspects of the operations of 1005 may be performed by a loading component 725 as described with reference to FIG. 7.

At 1010, the method may include receiving, via a first user input in the user interface, a selection of a source element and an event associated with the source element, wherein the event comprises transmission of a data packet from the source element in response to a trigger at the source element, and wherein the event and a payload of the data packet are configured in accordance with the metadata associated with the source element. The operations of 1010 may be performed in accordance with examples as disclosed herein. In some examples, aspects of the operations of 1010 may be performed by a trigger reception component 730 as described with reference to FIG. 7.

At 1015, the method may include receiving, via the first user input in the user interface, a selection of an interaction associated with the source element. The operations of 1015 may be performed in accordance with examples as disclosed herein. In some examples, aspects of the operations of 1015 may be performed by an interaction component 745 as described with reference to FIG. 7.

At 1020, the method may include receiving, via the second user input in the user interface, a selection of a corresponding interaction associated with the target element. The operations of 1020 may be performed in accordance with examples as disclosed herein. In some examples, aspects of the operations of 1020 may be performed by an interaction component 745 as described with reference to FIG. 7.

At 1025, the method may include receiving, via a second user input in the user interface, a selection of a target element and an input field for the target element, wherein the input field corresponds to the event associated with the source element. The operations of 1025 may be performed in accordance with examples as disclosed herein. In some examples, aspects of the operations of 1025 may be performed by a target selection component 735 as described with reference to FIG. 7.

At 1030, the method may include storing a dynamic interaction between the source element and the target element for the application. The operations of 1030 may be performed in accordance with examples as disclosed herein. In some examples, aspects of the operations of 1030 may be performed by a storage component 740 as described with reference to FIG. 7.

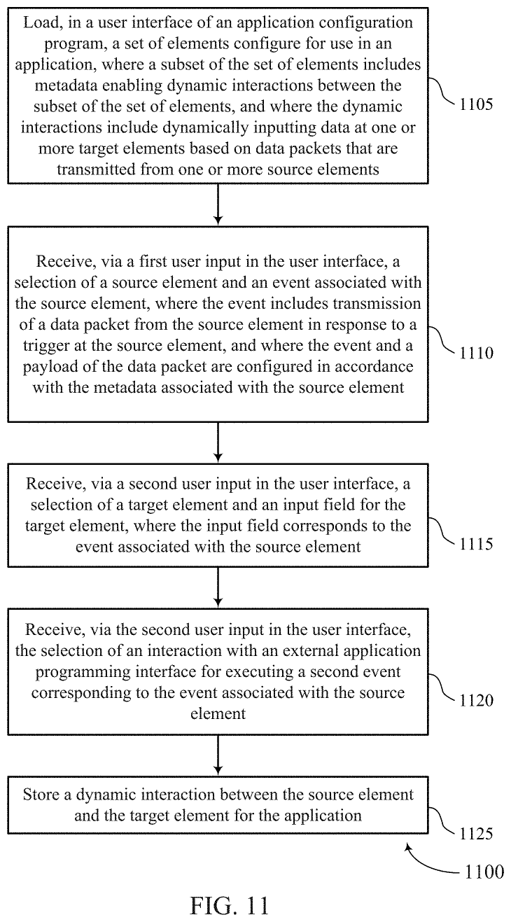

FIG. 11 shows a flowchart illustrating a method 1100 that supports configuring dynamic interactions between application elements in accordance with aspects of the present disclosure. The operations of the method 1100 may be implemented by an application server or its components as described herein. For example, the operations of the method 1100 may be performed by an application server as described with reference to FIGS. 1 through 8. In some examples, an application server may execute a set of instructions to control the functional elements of the application server to perform the described functions. Additionally or alternatively, the application server may perform aspects of the described functions using special-purpose hardware.

At 1105, the method may include loading, in a user interface of an application configuration program, a set of elements configured for use in an application, wherein a subset of the set of elements comprises metadata enabling dynamic interactions between the subset of the set of elements, and wherein the dynamic interactions comprise dynamically inputting data at one or more target elements based at least in part on data packets that are transmitted from one or more source elements. The operations of 1105 may be performed in accordance with examples as disclosed herein. In some examples, aspects of the operations of 1105 may be performed by a loading component 725 as described with reference to FIG. 7.

At 1110, the method may include receiving, via a first user input in the user interface, a selection of a source element and an event associated with the source element, wherein the event comprises transmission of a data packet from the source element in response to a trigger at the source element, and wherein the event and a payload of the data packet are configured in accordance with the metadata associated with the source element. The operations of 1110 may be performed in accordance with examples as disclosed herein. In some examples, aspects of the operations of 1110 may be performed by a trigger reception component 730 as described with reference to FIG. 7.

At 1115, the method may include receiving, via a second user input in the user interface, a selection of a target element and an input field for the target element, wherein the input field corresponds to the event associated with the source element. The operations of 1115 may be performed in accordance with examples as disclosed herein. In some examples, aspects of the operations of 1115 may be performed by a target selection component 735 as described with reference to FIG. 7.

At 1120, the method may include receiving, via the second user input in the user interface, the selection of an interaction with an external application programming interface for executing a second event corresponding to the event associated with the source element. The operations of 1120 may be performed in accordance with examples as disclosed herein. In some examples, aspects of the operations of 1120 may be performed by an interaction component 745 as described with reference to FIG. 7.

At 1125, the method may include storing a dynamic interaction between the source element and the target element for the application. The operations of 1125 may be performed in accordance with examples as disclosed herein. In some examples, aspects of the operations of 1125 may be performed by a storage component 740 as described with reference to FIG. 7.

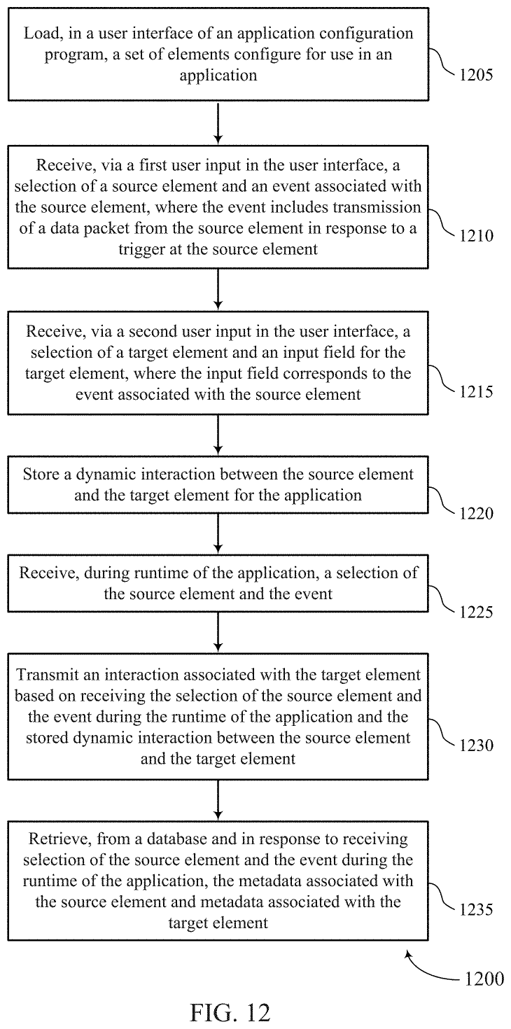

FIG. 12 shows a flowchart illustrating a method 1200 that supports configuring dynamic interactions between application elements in accordance with aspects of the present disclosure. The operations of the method 1200 may be implemented by an application server or its components as described herein. For example, the operations of the method 1200 may be performed by an application server as described with reference to FIGS. 1 through 8. In some examples, an application server may execute a set of instructions to control the functional elements of the application server to perform the described functions. Additionally or alternatively, the application server may perform aspects of the described functions using special-purpose hardware.

At 1205, the method may include loading, in a user interface of an application configuration program, a set of elements configured for use in an application, wherein a subset of the set of elements comprises metadata enabling dynamic interactions between the subset of the set of elements, and wherein the dynamic interactions comprise dynamically inputting data at one or more target elements based at least in part on data packets that are transmitted from one or more source elements. The operations of 1205 may be performed in accordance with examples as disclosed herein. In some examples, aspects of the operations of 1205 may be performed by a loading component 725 as described with reference to FIG. 7.

At 1210, the method may include receiving, via a first user input in the user interface, a selection of a source element and an event associated with the source element, wherein the event comprises transmission of a data packet from the source element in response to a trigger at the source element, and wherein the event and a payload of the data packet are configured in accordance with the metadata associated with the source element. The operations of 1210 may be performed in accordance with examples as disclosed herein. In some examples, aspects of the operations of 1210 may be performed by a trigger reception component 730 as described with reference to FIG. 7.

At 1215, the method may include receiving, via a second user input in the user interface, a selection of a target element and an input field for the target element, wherein the input field corresponds to the event associated with the source element. The operations of 1215 may be performed in accordance with examples as disclosed herein. In some examples, aspects of the operations of 1215 may be performed by a target selection component 735 as described with reference to FIG. 7.

At 1220, the method may include storing a dynamic interaction between the source element and the target element for the application. The operations of 1220 may be performed in accordance with examples as disclosed herein. In some examples, aspects of the operations of 1220 may be performed by a storage component 740 as described with reference to FIG. 7.

At 1225, the method may include receiving, during runtime of the application, a selection of the source element and the event. The operations of 1225 may be performed in accordance with examples as disclosed herein. In some examples, aspects of the operations of 1225 may be performed by an element component 750 as described with reference to FIG. 7.

At 1230, the method may include transmitting an interaction associated with the target element based at least in part on receiving the selection of the source element and the event during the runtime of the application and the stored dynamic interaction between the source element and the target element. The operations of 1230 may be performed in accordance with examples as disclosed herein. In some examples, aspects of the operations of 1230 may be performed by an interaction component 745 as described with reference to FIG. 7.

At 1235, the method may include retrieving, from a database and in response to receiving selection of the source element and the event during the runtime of the application, the metadata associated with the source element and metadata associated with the target element, wherein transmitting the interaction is based at least in part on retrieving the metadata associated with the source element and the metadata associated with the target element. The operations of 1235 may be performed in accordance with examples as disclosed herein. In some examples, aspects of the operations of 1235 may be performed by a metadata retrieval component 755 as described with reference to FIG. 7.

A method for data processing at an application server is described. The method may include loading, in a user interface of an application configuration program, a set of elements configured for use in an application, wherein a subset of the set of elements comprises metadata enabling dynamic interactions between the subset of the set of elements, and wherein the dynamic interactions comprise dynamically inputting data at one or more target elements based at least in part on data packets that are transmitted from one or more source elements, receiving, via a first user input in the user interface, a selection of a source element and an event associated with the source element, wherein the event comprises transmission of a data packet from the source element in response to a trigger at the source element, and wherein the event and a payload of the data packet are configured in accordance with the metadata associated with the source element, receiving, via a second user input in the user interface, a selection of a target element and an input field for the target element, wherein the input field corresponds to the event associated with the source element, and storing a dynamic interaction between the source element and the target element for the application.

An apparatus for data processing at an application server is described. The apparatus may include a processor, memory coupled with the processor, and instructions stored in the memory. The instructions may be executable by the processor to cause the apparatus to loading, in a user interface of an application configuration program, a set of elements configure for use in an application, wherein a subset of the set of elements comprises metadata enabling dynamic interactions between the subset of the set of elements, and wherein the dynamic interactions comprise dynamically inputting data at one or more target elements based at least in part on data packets that are transmitted from one or more source elements, receive, via a first user input in the user interface, a selection of a source element and an event associated with the source element, wherein the event comprises transmission of a data packet from the source element in response to a trigger at the source element, and wherein the event and a payload of the data packet are configured in accordance with the metadata associated with the source element, receive, via a second user input in the user interface, a selection of a target element and an input field for the target element, wherein the input field corresponds to the event associated with the source element, and store a dynamic interaction between the source element and the target element for the application.

Another apparatus for data processing at an application server is described. The apparatus may include means for loading, in a user interface of an application configuration program, a set of elements configured for use in an application, wherein a subset of the set of elements comprises metadata enabling dynamic interactions between the subset of the set of elements, and wherein the dynamic interactions comprise dynamically inputting data at one or more target elements based at least in part on data packets that are transmitted from one or more source elements, means for receiving, via a first user input in the user interface, a selection of a source element and an event associated with the source element, wherein the event comprises transmission of a data packet from the source element in response to a trigger at the source element, and wherein the event and a payload of the data packet are configured in accordance with the metadata associated with the source element, means for receiving, via a second user input in the user interface, a selection of a target element and an input field for the target element, wherein the input field corresponds to the event associated with the source element, and means for storing a dynamic interaction between the source element and the target element for the application.

A non-transitory computer-readable medium storing code for data processing at an application server is described. The code may include instructions executable by a processor to loading, in a user interface of an application configuration program, a set of elements configure for use in an application, wherein a subset of the set of elements comprises metadata enabling dynamic interactions between the subset of the set of elements, and wherein the dynamic interactions comprise dynamically inputting data at one or more target elements based at least in part on data packets that are transmitted from one or more source elements, receive, via a first user input in the user interface, a selection of a source element and an event associated with the source element, wherein the event comprises transmission of a data packet from the source element in response to a trigger at the source element, and wherein the event and a payload of the data packet are configured in accordance with the metadata associated with the source element, receive, via a second user input in the user interface, a selection of a target element and an input field for the target element, wherein the input field corresponds to the event associated with the source element, and store a dynamic interaction between the source element and the target element for the application.

Some examples of the method, apparatuses, and non-transitory computer-readable medium described herein may further include operations, features, means, or instructions for receiving, via the first user input in the user interface, a selection of an interaction associated with the source element and receiving, via the second user input in the user interface, a selection of a corresponding interaction associated with the target element. In some examples of the method, apparatuses, and non-transitory computer-readable medium described herein, receiving the selection of the corresponding interaction may include operations, features, means, or instructions for receiving, via the second user input in the user interface, the selection of the corresponding interaction from a drop down list of predefined interactions.

In some examples of the method, apparatuses, and non-transitory computer-readable medium described herein, receiving the selection of the target element and the input field may include operations, features, means, or instructions for receiving, via the second user input in the user interface, the selection of an interaction with an external application programming interface for executing a second event corresponding to the event associated with the source element.

In some examples of the method, apparatuses, and non-transitory computer-readable medium described herein, receiving the selection of the target element and the input field may include operations, features, means, or instructions for receiving, via the second user input in the user interface comprising a first webpage, the selection of a service configured to navigate to a second webpage in response to receiving the selection of the event associated with the source element.

In some examples of the method, apparatuses, and non-transitory computer-readable medium described herein, receiving the selection of the target element and the input field may include operations, features, means, or instructions for receiving, via the second user input in the user interface comprising a webpage, the selection of a service configured to navigate from a first tab to a second tab in the webpage in response to receiving the selection of the event associated with the source element.

Some examples of the method, apparatuses, and non-transitory computer-readable medium described herein may further include operations, features, means, or instructions for receiving, during runtime of the application, a selection of the source element and the event and transmitting an interaction associated with the target element based at least in part on receiving the selection of the source element and the event during the runtime of the application and the stored dynamic interaction between the source element and the target element.

Some examples of the method, apparatuses, and non-transitory computer-readable medium described herein may further include operations, features, means, or instructions for retrieving, from a database and in response to receiving selection of the source element and the event during the runtime of the application, the metadata associated with the source element and metadata associated with the target element, wherein transmitting the interaction may be based at least in part on retrieving the metadata associated with the source element and the metadata associated with the target element.

In some examples of the method, apparatuses, and non-transitory computer-readable medium described herein, the element comprises at least one of a component configured for use in the application, a service, an application programming interface, or a combination thereof. In some examples of the method, apparatuses, and non-transitory computer-readable medium described herein, the source element may be independent from the target component during loading the set of elements in the user interface of the application configuration program.

It should be noted that the methods described herein describe possible implementations, and that the operations and the steps may be rearranged or otherwise modified and that other implementations are possible. Further, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

1. A method for data processing at an application server, comprising:
loading a set of elements in a user interface of an application builder program for configuring interactions between the set of elements in an application, wherein a subset of the set of elements comprises metadata enabling dynamic interactions between the subset of the set of elements, and wherein the dynamic interactions comprise dynamically inputting data for automatically invoking a corresponding action at one or more target elements based at least in part on data packets associated with an action, that are transmitted from one or more source elements;
receiving, via a first user input in the user interface, a selection of a source element from the one or more source elements and an event associated with the source element, wherein the event comprises transmission of a data packet from the source element in response to a trigger at the source element, and wherein the event and a payload of the data packet comprising a schema for the event are configured in accordance with the metadata associated with the source element;
receiving, via a second user input in the user interface, a selection of a target element from the one or more target elements and an input field for the target element, wherein the input field comprises the corresponding trigger that is to be invoked in response to receiving the event associated with the source element; and
storing a file for generating a dynamic interaction between the source element and the target element for the application builder program.

2. The method of claim 1, further comprising:
receiving, via the first user input in the user interface, a selection of an interaction associated with the source element; and
receiving, via the second user input in the user interface, a selection of a corresponding interaction associated with the target element.

3. The method of claim 2, wherein receiving the selection of the corresponding interaction further comprises:
receiving, via the second user input in the user interface, the selection of the corresponding interaction from a drop down list of predefined interactions.

4. The method of claim 1, wherein receiving the selection of the target element and the input field further comprises:
receiving, via the second user input in the user interface, the selection of an interaction with an external application programming interface for executing a second event corresponding to the event associated with the source element.

5. The method of claim 1, wherein receiving the selection of the target element and the input field further comprises:
receiving, via the second user input in the user interface comprising a first webpage, the selection of a service configured to navigate to a second webpage in response to receiving the selection of the event associated with the source element.

6. The method of claim 1, wherein receiving the selection of the target element and the input field further comprises:
receiving, via the second user input in the user interface comprising a webpage, the selection of a service configured to navigate from a first tab to a second tab in the webpage in response to receiving the selection of the event associated with the source element.

7. The method of claim 1, further comprising:
receiving, during runtime of the application, a selection of the source element and the event; and
transmitting an interaction associated with the target element based at least in part on receiving the selection of the source element and the event during the runtime of the application and the stored file for generating the dynamic interaction between the source element and the target element.

8. The method of claim 7, further comprising:
retrieving, from a database and in response to receiving selection of the source element and the event during the runtime of the application, the metadata associated with the source element and metadata associated with the target element, wherein transmitting the interaction is based at least in part on retrieving the metadata associated with the source element and the metadata associated with the target element.

9. The method of claim 1, wherein the source element or the target element or both comprises at least one of a component configured for use in the application, a service, an application programming interface, or a combination thereof.

10. The method of claim 1, wherein the source element is independent from the target element during loading the set of elements in the user interface of the application builder program.

11. An apparatus for data processing at an application server, comprising:
a processor;
memory coupled with the processor; and
instructions stored in the memory and executable by the processor to cause the apparatus to:
load a set of elements in a user interface of an application builder program for configuring interactions between the set of elements in an application, wherein a subset of the set of elements comprises metadata enabling dynamic interactions between the subset of the set of elements, and wherein the dynamic interactions comprise dynamically inputting data for automatically invoking a corresponding action at one or more target elements based at least in part on data packets associated with an action, that are transmitted from one or more source elements;
receive, via a first user input in the user interface, a selection of a source element from the one or more source elements and an event associated with the source element, wherein the event comprises transmission of a data packet from the source element in response to a trigger at the source element, and wherein the event and a payload of the data packet comprising a schema for the event are configured in accordance with the metadata associated with the source element;
receive, via a second user input in the user interface, a selection of a target element from the one or more target elements and an input field for the target element, wherein the input field comprises the corresponding trigger that is to be invoked in response to receiving the event associated with the source element; and
store a file for generating a dynamic interaction between the source element and the target element for the application builder program.

12. The apparatus of claim 11, wherein the instructions are further executable by the processor to cause the apparatus to:
receive, via the first user input in the user interface, a selection of an interaction associated with the source element; and
receive, via the second user input in the user interface, a selection of a corresponding interaction associated with the target element.

13. The apparatus of claim 12, wherein the instructions to receive the selection of the corresponding interaction are further executable by the processor to cause the apparatus to:
receive, via the second user input in the user interface, the selection of the corresponding interaction from a drop down list of predefined interactions.

14. The apparatus of claim 11, wherein the instructions to receive the selection of the target element and the input field are further executable by the processor to cause the apparatus to:
receive, via the second user input in the user interface, the selection of an interaction with an external application programming interface for executing a second event corresponding to the event associated with the source element.

15. The apparatus of claim 11, wherein the instructions to receive the selection of the target element and the input field are further executable by the processor to cause the apparatus to:
receive, via the second user input in the user interface comprising a first webpage, the selection of a service configured to navigate to a second webpage in response to receiving the selection of the event associated with the source element.

16. The apparatus of claim 11, wherein the instructions to receive the selection of the target element and the input field are further executable by the processor to cause the apparatus to:
receive, via the second user input in the user interface comprising a webpage, the selection of a service configured to navigate from a first tab to a second tab in the webpage in response to receiving the selection of the event associated with the source element.

17. The apparatus of claim 11, wherein the instructions are further executable by the processor to cause the apparatus to:
receive, during runtime of the application, a selection of the source element and the event; and
transmit an interaction associated with the target element based at least in part on receiving the selection of the source element and the event during the runtime of the application and the stored file for generating the dynamic interaction between the source element and the target element.

18. The apparatus of claim 17, wherein the instructions are further executable by the processor to cause the apparatus to:
retrieve, from a database and in response to receiving selection of the source element and the event during the runtime of the application, the metadata associated with the source element and metadata associated with the target element, wherein transmitting the interaction is based at least in part on retrieving the metadata associated with the source element and the metadata associated with the target element.

19. The apparatus of claim 11, wherein the source element or the target element or both comprise at least one of a component configured for use in the application, a service, an application programming interface, or a combination thereof.

20. A non-transitory computer-readable medium storing code for data processing at an application server, the code comprising instructions executable by a processor to:
load a set of elements in a user interface of an application builder program for configuring interactions between the set of elements in an application, wherein a subset of the set of elements comprises metadata enabling dynamic interactions between the subset of the set of elements, and wherein the dynamic interactions comprise dynamically inputting data for automatically invoking a corresponding action at one or more target elements based at least in part on data packets associated with an action, that are transmitted from one or more source elements;
receive, via a first user input in the user interface, a selection of a source element from the one or more source elements and an event associated with the source element, wherein the event comprises transmission of a data packet from the source element in response to a trigger at the source element, and wherein the event and a payload of the data packet comprising a schema for the event are configured in accordance with the metadata associated with the source element;
receive, via a second user input in the user interface, a selection of a target element from the one or more target elements and an input field for the target element, wherein the input field comprises the corresponding trigger that is to be invoked in response to receiving the event associated with the source element; and
store a file for generating a dynamic interaction between the source element and the target element for the application builder program.
